(19) United States
(12) Patent Application Publication
(10) Pub. No.: US 2025/0334524 A1
(43) Pub. Date: Oct. 30, 2025

(54) SUBSTRATE INSPECTION APPARATUS

(71) Applicants: ELECTRONICS AND TELECOMMUNICATIONS RESEARCH INSTITUTE, Daejeon (KR); BlueTileLab, Inc, Daejeon (KR)

(72) Inventors: Hyung Woo KIM, Incheon (KR); Dong Hoon SONG, Daejeon (KR); Hong-Seok SEO, Daejeon (KR)

(21) Appl. No.: 19/078,698

(22) Filed: Mar. 13, 2025

(30) Foreign Application Priority Data
Apr. 24, 2024 (KR) 10-2024-0054976
Jul. 31, 2024 (KR) 10-2024-0102079

(51) Int. Cl. G01N 21/88

(52) U.S. Cl. CPC G01N 21/8806; G01N 2021/8845; G01N 2201/0636; G01N 2201/0638

(57) ABSTRACT

Provided is a substrate inspection apparatus which includes a stage to accommodate a substrate, an image sensor disposed on the stage, an objective lens disposed between the image sensor and the stage to project an image of the substrate, an imaging optical system disposed between the objective lens and the image sensor, a first main beam splitter disposed between the imaging optical system and the objective lens, a first illumination light source disposed at one side of the first main beam splitter to provide first illumination light to a first depth of the substrate, and a second illumination light source disposed adjacent to the first illumination light source to provide second illumination light source, which has a wavelength shorter than that of the first illumination light source, to a second depth, which is shallower than the first depth, through the first main beam splitter.

### CROSS-REFERENCE TO RELATED APPLICATIONS

This U.S. non-provisional patent application claims priority under 35 U.S.C. § 119 of Korean Patent Application Nos. 10-2024-0054976, filed on Apr. 24, 2024, and 10-2024-0102079, filed on Jul. 31, 2024, the entire contents of which are hereby incorporated by reference.

### BACKGROUND

### 1. Field of the Invention

The present disclosure herein relates to a substrate inspection apparatus, and more particularly, to a substrate inspection apparatus including a plurality of illumination light sources.

### 2. Description of Related Art

Recently, near-infrared nanosecond laser light has been widely employed as illumination for industrial semiconductor inspection apparatus, playing a crucial role in inspection applications based on the thickness of a substrate and the thin film deposited on it. Furthermore, nanosecond laser light has been effectively utilized as irradiation light for measuring particle contamination and detecting damage in thin films.

### SUMMARY

The present disclosure provides an illumination light source capable of detecting defects at various depths within a substrate, and a substrate inspection apparatus including the same.

An embodiment of the inventive concept provides a substrate inspection apparatus. The substrate inspection apparatus includes a stage configured to accommodate a substrate; an image sensor disposed on the stage; an objective lens disposed between the image sensor and the stage and configured to project an image of the substrate; an imaging optical system disposed between the objective lens and the image sensor; a first main beam splitter disposed between the imaging optical system and the objective lens; a first illumination light source disposed at one side of the first main beam splitter and configured to provide first illumination light to a first depth of the substrate; and a second illumination light source disposed adjacent to the first illumination light source and configured to provide second illumination light source, which has a wavelength shorter than that of the first illumination light source, to a second depth, which is shallower than the first depth, through the first main beam splitter.

In an embodiment, the first illumination light may have a first wavelength of about 910 nm, and the second illumination light may have a second wavelength of about 800 nm.

In an embodiment, the substrate inspection apparatus may further include a holographic phase pattern disposed between the first main beam splitter and the objective lens and configured to increase in focal depth of each of the first and second illumination light.

In an embodiment, the holographic phase pattern may have a donut shape.

In an embodiment, the substrate inspection apparatus may further include a controller configured to acquire first and second images by using a detection signal acquired from the image sensor; and a digital delay pulse generator connected between the first and second illumination light sources and the controller to provide pulses to the first and second illumination light sources.

In an embodiment, the substrate inspection apparatus may further include a first quarter wave plate disposed between the first illumination light source and the first main beam splitter; a first auxiliary beam splitter disposed between the first illumination light source and the first quarter wave plate and configured to transmit the first illumination light and reflect the second illumination light to the first quarter wave plate; and a first nonlinear crystal plate disposed between the first illumination light source and the first auxiliary beam splitter and having a first thickness.

In an embodiment, the substrate inspection apparatus may further include a first mirror disposed between the second illumination light source and the first auxiliary beam splitter; and a second nonlinear crystal plate disposed between the first mirror and the second illumination light source and having a second thickness, which is less than the first thickness.

In an embodiment, the substrate inspection apparatus may further include a second main beam splitter disposed between the objective lens and the imaging optical system and arranged in a direction intersecting the first main beam splitter; a third illumination light source disposed at one side of the second main beam splitter and configured to provide third illumination light having a third wavelength, which is shorter than the second wavelength of the second illumination light; a second auxiliary beam splitter disposed between the third illumination light source and the second main beam splitter; and a third nonlinear crystal plate disposed between the third illumination light source and the second auxiliary beam splitter and having a third thickness, which Is less than the second thickness.

In an embodiment, the substrate inspection apparatus may further include a fourth illumination light source disposed adjacent to the third illumination light source and configured to provide fourth illumination light having a fourth wavelength, which is shorter than the third wavelength, to the second auxiliary beam splitter.

In an embodiment, the substrate inspection apparatus may further include a second mirror disposed between the fourth illumination light source and the second auxiliary beam splitter; and a fourth nonlinear crystal plate having a fourth thickness, which is less than the third thickness.

In an embodiment of the inventive concept, a substrate inspection apparatus includes: a stage configured to accommodate a substrate; an image stage disposed on the stage; an objective lens disposed on the image sensor and the stage; an imaging optical system disposed between the objective lens and the image sensor; first and second main beam splitters disposed between the imaging optical system and the objective lens; first and second illumination light sources disposed at one side of the first and second main beam splitters to provide first and second illumination light to the substrate, respectively; and third and fourth illumination light sources disposed at the other side of the first and second main beam splitters to provide third and fourth illumination light to the substrate, respectively.

In an embodiment the substrate inspection apparatus may further include a first nonlinear crystal plate disposed between the first and second main beam splitters and the first illumination light source and having a first thickness; and a second nonlinear crystal plate disposed between the first and second main beam splitters and the second illumination light source and having a second thickness, which is less than the first thickness, wherein the first thickness ranges from about 13 mm to about 15 mm, and the second thickness ranges from about 9 mm to 11 about mm.

In an embodiment, the substrate inspection apparatus may further include a third nonlinear crystal plate disposed between the first and second main beam splitters and the third illumination light source and having a third thickness; and a fourth nonlinear crystal plate disposed between the first and second main beam splitters and the fourth illumination light source and having a fourth thickness, which is less than the third thickness.

In an embodiment, the third thickness may range from about 5 mm to about 7 mm, and the fourth thickness may range from about 1 mm to about 3 mm.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a view illustrating an example of a substrate inspection apparatus according to an embodiment of the inventive concept;

FIG. 2 is a graph showing an example of wavelengths of first and second illumination light shown in FIG. 1;

FIG. 3 is a view showing an example of a holographic phase pattern of FIG. 1;

FIG. 4 is cross-sectional views illustrating examples of defect identification using the first and second illumination light of FIG. 1;

FIG. 5 is a view illustrating an example of a substrate inspection apparatus according to an embodiment of the inventive concept;

FIG. 6 is a graph showing an example of wavelengths of first and second illumination light shown in FIG. 5;

FIG. 7 is a view showing an example of a vortex beam of the first illumination light of FIG. 1;

FIG. 8 is a view showing examples of holographic phase patterns of FIG. 1; and

FIG. 9 is a view illustrating an example of a substrate inspection apparatus according to an embodiment of the inventive concept.

### DETAILED DESCRIPTION

Hereinafter, preferred embodiments of the inventive concept will be described in detail with reference to the accompanying drawings. Advantages and features of the inventive concept, and implementation methods thereof will be clarified through following embodiments described with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art, and the inventive concept is only defined by the scope of the claims. Like reference numerals refer to like elements throughout.

The terms used in this specification are used only to explain embodiments while not limiting the present disclosure. In this specification, the singular forms include the plural forms as well, unless the context clearly indicates otherwise. The meaning of ‘comprises’ and/or ‘comprising’ specifies a component, an operation and/or an element does not exclude other components, operations and/or elements. Since preferred embodiments are provided below, the order of the reference numerals given in the description is not limited thereto.

Additionally, the embodiments described in this specification will be explained with reference to the cross-sectional views and/or plan views as ideal exemplary views of the present disclosure. In the drawing, the thicknesses of films and regions are exaggerated for effective description of the technical contents. Accordingly, shapes of the exemplary views may be modified according to manufacturing techniques and/or allowable errors. Therefore, the embodiments of the inventive concept are not limited to the specific shape illustrated in the exemplary views, but may include other shapes that are created according to manufacturing processes.

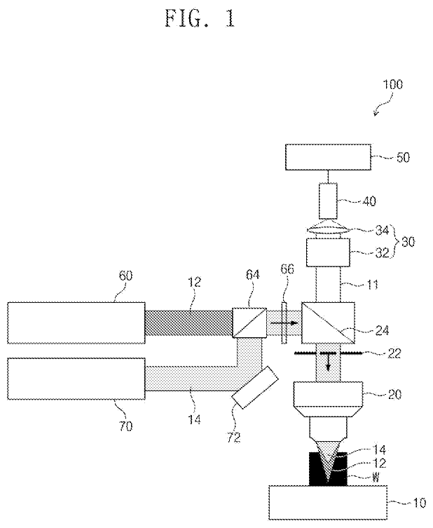

FIG. 1 illustrates an example of a substrate inspection apparatus 100 according to an embodiment of the inventive concept.

Referring to FIG. 1, the substrate inspection apparatus 100 of the inventive concept may include an optical microscope device. According to an example, the substrate inspection apparatus 100 of the inventive concept may include a stage 10, an objective lens 20, an imaging system 30, an image sensor 40, a controller 50, a first illumination light source 60, and a second illumination light source 70.

The stage 10 may accommodate a substrate W. The controller 50 may control the stage 10 to move the substrate W. During the inspection and measurement processes of the substrate W, the stage 10 may be moved in a direction parallel to the substrate W.

The objective lens 20 may be disposed above the stage 10. The objective lens 20 may magnify and project an image of the substrate W onto the image sensor 40. For example, the objective lens 20 may have a numerical aperture NA of 1 or less.

A first main beam splitter 24 may be provided on the objective lens 20. The first main beam splitter 24 may allow reflected light 11 to pass through the imaging system 30 and reflect the first illumination light 12 and the second illumination light 14 to the objective lens 20. The first main beam splitter 24 may include a dichroic mirror.

The imaging system 30 may be disposed between the first main beam splitter 24 and the image sensor 40. The imaging system 30 may project an image of the substrate W onto the image sensor 40 using the reflected light 11. According to an example, the imaging system 30 may include an imaging relay lens 32 and an ocular lens 34. The imaging relay lens 32 may be controlled to adjust a distance between the objective lens 20 and the ocular lens 34. The ocular lens 34 may be disposed between the imaging relay lens 32 and the image sensor 40. The ocular lens 34 may form the image of the substrate W on the image sensor 40 using the reflected light 11. The ocular lens 34 may include a tube lens. The magnification of the image of the substrate W may be calculated as the product of the magnification of the objective lens 20 and the magnification of the ocular lens 34. Although not shown, an imaging polarizer and an imaging aperture may be provided between the imaging relay lens 32 and the ocular lens 34. The imaging polarizer may polarize the reflected light 11. The imaging aperture may define the beam size of the reflected light 11.

The image sensor 40 may be disposed on the ocular lens 34. The image sensor 40 may receive light 11 (hereinafter referred to as ‘reflected light’), which is reflected from the substrate W. The image sensor 40 may acquire an image signal of the substrate W using the reflected light 11. The image sensor 40 may include a charge-coupled device (CCD) or a complementary metal-oxide-semiconductor (CMOS) image sensor.

The controller 50 may be connected to the image sensor 40. The controller 50 may acquire an image of the substrate W using an image detection signal of the image sensor 40. The controller 50 may control the first illumination light source 60 and the second illumination light source 70.

The first illumination light source 60 may be disposed at one side of the objective lens 20 and the first main beam splitter 24. The first illumination light source 60 may provide first illumination light 12 to the substrate W. The first illumination light 12 may be reflected on the substrate W and generate the reflected light 11. The first illumination light 12 may generate a broadband image of the substrate W. For example, the first illumination light 12 may have a first wavelength of approximately 910 nm.

The second illumination light source 70 may be provided adjacent to the first illumination light source 60. The second illumination light source 70 may provide second illumination light 14 to the substrate W. The second illumination light 14 may have a second wavelength that is shorter than the first wavelength of the first illumination light 12. For example, the second illumination light 14 may have a second wavelength of approximately 800 nm. The second illumination light 14 may penetrate to a shallower depth within the substrate W than the first illumination light 12. Near-infrared light with a wavelength of 600 nm or more may have an absorption coefficient that is inversely proportional to the wavelength. Accordingly, the first illumination light 12 may penetrate to a greater depth within the substrate W than the second illumination light 14.

Although not shown, the first illumination light source 60 and the second illumination light source 70 may include gain mediums and pump light sources. The gain mediums may include titanium sapphire. The pump light sources may include a pulsed laser having a wavelength of approximately 532 nm. The first illumination light source 60 may generate the first illumination light 12, and the second illumination light source 70 may generate the second illumination light 14, each of which is near-infrared light having a wavelength of approximately 650 nm to approximately 1100 nm by a gain switching method. When the pump light sources are provided to the gain mediums, the first illumination light 12 and the second illumination light 14 may oscillate after a buildup time of approximately 42 nsec.

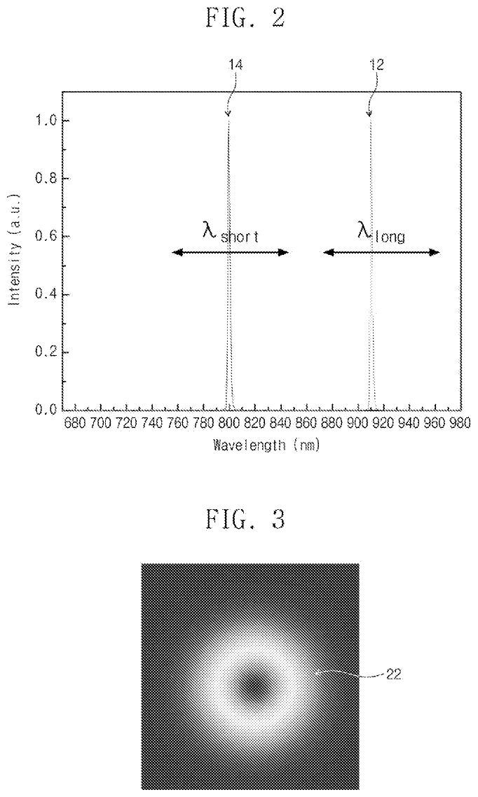

FIG. 2 shows an example of the wavelengths of the first illumination light 12 and the second illumination light 14 of FIG. 1.

Referring to FIG. 2, for example, the first illumination light 12 and the second illumination light 14 may have peak wavelengths of approximately 910 nm and 800 nm, respectively.

Referring to FIG. 1, a first auxiliary beam splitter 64 may be provided between the first illumination light source 60 and the first main beam splitter 24. The first auxiliary beam splitter 64 may allow the first illumination light 12 to pass through the first main beam splitter 24. The first auxiliary beam splitter 64 may reflect the second illumination light 14 to the first main beam splitter 24. The first auxiliary beam splitter 64 may allow the first illumination light 12 and the second illumination light 14 to be polarized.

A first mirror 72 may be provided between the first auxiliary beam splitter 64 and the second illumination light source 70. The first mirror 72 may reflect the second illumination light 14 to the first auxiliary beam splitter 64.

A quarter-wave plate 66 may be provided between the first auxiliary beam splitter 64 and the first main beam splitter 24. The quarter-wave plate 66 may delay the phase of the first illumination light 12 and the second illumination light 14, thereby polarizing the first illumination light 12 and the second illumination light 14. The second illumination light 14 may be circularly or elliptically polarized. For example, the quarter-wave plate 66 may transform the circularly polarized first illumination light 12 and second illumination light 14 into vortex beams. The first illumination light 12 and the second illumination light 14 may be reflected from the first main beam splitter 24 to the objective lens 20.

A holographic phase pattern 22 may be provided between the first main beam splitter 24 and the objective lens 20. The holographic phase pattern 22 may increase in focal depth of each of the first illumination light 12 and the second illumination light 14. Although not shown, the holographic phase pattern 22 may be generated by a spatial light modulator (SLM) provided at the other side of the objective lens 20 and the first main beam splitter 24.

FIG. 3 shows an example of the holographic phase pattern 22 of FIG. 1.

Referring to FIG. 3, the holographic phase pattern 22 may have a donut shape or a ring shape.

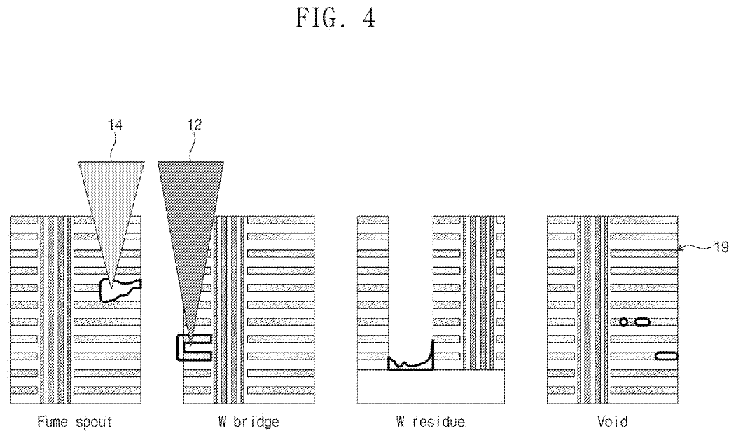

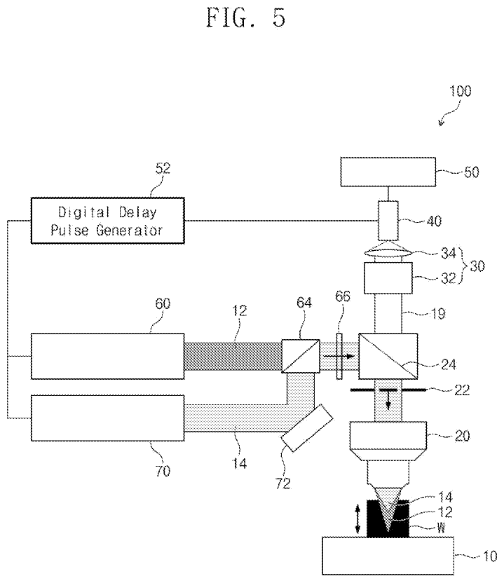

FIG. 4 illustrates an example of defect identification using the first illumination light 12 and the second illumination light 14 of FIG. 1.

Referring to FIG. 4, the substrate inspection apparatus 100 of the inventive concept may detect defects such as fume spouts, bridges, residues, and voids in a 3D NAND flash memory device 19 by using the first illumination light 12 and the second illumination light 14. The 3D NAND flash memory device 19 may be provided on the substrate W. According to an example, the first illumination light 12 may be provided to a first depth, and the second illumination light 14 may be provided to a second depth, which is shallower than the first depth. For example, the first illumination light 12 may be used to detect bridge defects at the first depth. The second illumination light 14 may be used to detect fume spout defects at the second depth, which is shallower than the first depth. That is, the second illumination light 14 may detect defects at the second depth, which is shallower than the first depth of the first illumination light 12.

Accordingly, the substrate inspection apparatus 100 according to the inventive concept may detect defects at various depths of the substrate W using the first illumination light 12 and the second illumination light 14 having different wavelengths. Furthermore, the substrate inspection apparatus 100 according to the inventive concept may measure the presence, size, location, and shape of the defects.

FIG. 5 illustrates an example of the substrate inspection apparatus 100 according to an embodiment of the inventive concept.

Referring to FIG. 5, the substrate inspection apparatus 100 of the inventive concept may further include a digital delay pulse generator 52. The digital delay pulse generator 52 may connect the first illumination light source 60 and the second illumination light source 70 to the controller 50. The digital delay pulse generator 52 may be controlled by the controller 50 to generate pulses. The digital delay pulse generator 52 may provide the pulses to the first illumination light source 60 and the second illumination light source 70 to increase the bandwidths of the first illumination light 12 and the second illumination light 14.

A stage 10, an objective lens 20, an imaging optical system 30, an image sensor 40, a controller 50, the first illumination light source 60, and the second illumination light source 70 may have the same configuration as in FIG. 1.

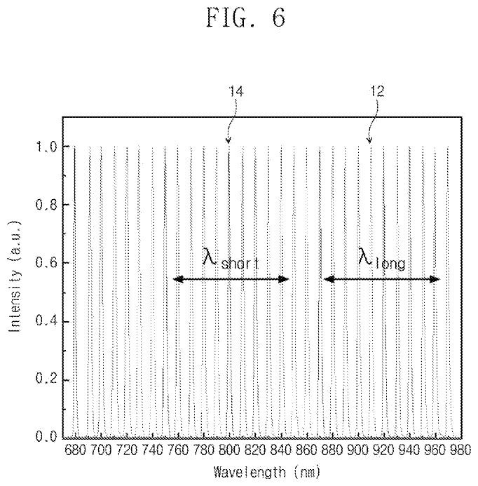

FIG. 6 shows an example of the wavelengths of the first illumination light 12 and the second illumination light 14 in FIG. 5.

Referring to FIG. 6, the first illumination light 12 and the second illumination light 14 may have comb peak wavelengths. For example, the first illumination light 12 and the second illumination light 14 may have comb peak wavelengths ranging from approximately 680 nm to approximately 980 nm. Each of the comb peak wavelengths may have a bandwidth of approximately 1 nm (Full-Width at Half Maximum: FWHM).

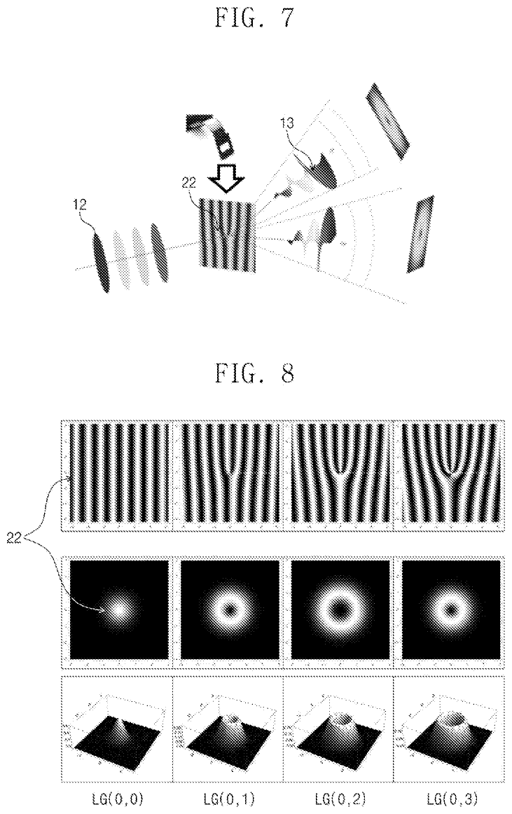

FIG. 7 shows an example of a vortex beam 13 of the first illumination light 12 in FIG. 1.

Referring to FIG. 7, the first illumination light 12 may be modulated or transformed into the vortex beam 13 by a holographic phase pattern 22. The vortex beam 13 may facilitate distinguishing the type and size of defects within the substrate W.

FIG. 8 shows examples of the holographic phase pattern 22 in FIG. 1.

Referring to FIG. 8, the holographic phase pattern 22 may have a striped shape, a circular shape, or a donut shape. The circular holographic phase pattern 22 may generate a vortex beam having a mode value of LG (0,0) in Gaussian distribution by using the first illumination light 12. The donut-shaped holographic phase pattern 22 may generate vortex beams having higher-order mode values of LG (0,1), LG (0,2), and LG (0,3).

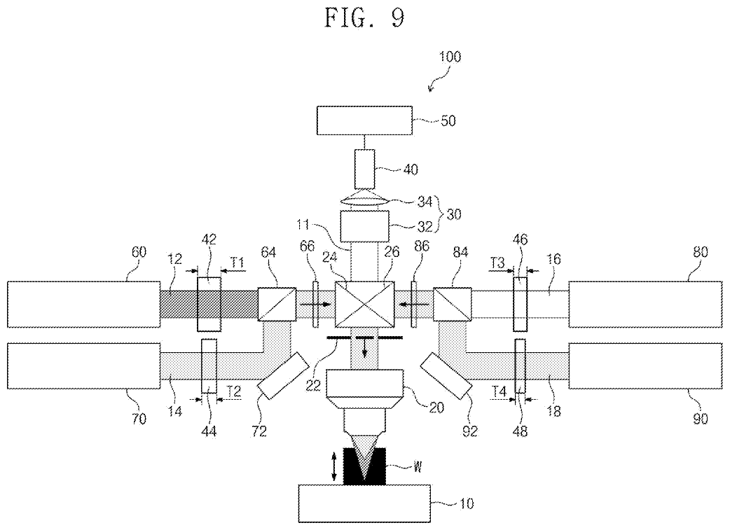

FIG. 9 illustrates an example of the substrate inspection apparatus 100 according to an embodiment of the inventive concept.

Referring to FIG. 9, the substrate inspection apparatus 100 according to the inventive concept may further include a first nonlinear crystal plate 42, a second nonlinear crystal plate 44, a third illumination light source 80, a third nonlinear crystal plate 46, a fourth illumination light source 90, and a fourth nonlinear crystal plate 48.

The first nonlinear crystal plate 42 may be provided between the first illumination light source 60 and the first auxiliary beam splitter 64. The first nonlinear crystal plate 42 may increase the bandwidth of the first illumination light 12. For example, the first nonlinear crystal plate 42 may have a first thickness T1 of approximately 13 mm to approximately 15 mm. The first nonlinear crystal plate 42 may include BBO (Beta Barium Borate), PPKTP (Periodically Poled Potassium Titanyl Phosphate), and PPLN (Periodically Poled Lithium Niobate). The first nonlinear crystal plate 42 may further include silicon (Si), silicon nitride (SiN), aluminum gallium arsenide (AlGaAs), or silicon carbide (SiC).

The second nonlinear crystal plate 44 may be provided between the second illumination light source 70 and the first mirror 72. The second nonlinear crystal plate 44 may increase the bandwidth of the second illumination light 14. The second nonlinear crystal plate 44 may have a second thickness T2, which is less than the first thickness T1. The second thickness T2 may range from approximately 9 mm to approximately 11 mm. The second nonlinear crystal plate 44 may include BBO (Beta Barium Borate), PPKTP (Periodically Poled Potassium Titanyl Phosphate), PPLN (Periodically Poled Lithium Niobate), silicon (Si), silicon nitride (SiN), aluminum gallium arsenide (AlGaAs), or silicon carbide (SiC).

The third illumination light source 80 may be provided at the other side of the first main beam splitter 24 facing the first illumination light source 60. The third illumination light source 80 may provide third illumination light 16 to the substrate W. The third illumination light 16 may have a shorter wavelength than that of each of the first illumination light 12 and the second illumination light 14. The third illumination light 16 may have a wavelength of approximately 700 nm.

A second main beam splitter 26 may be provided between the first illumination light source 60 and the third illumination light source 80. The second main beam splitter 26 may be disposed in a direction intersecting with the first main beam splitter 24. The second main beam splitter 26 may reflect the third illumination light 16 toward the objective lens 20 and transmit the reflected light 11 to the imaging optical system 30.

A second auxiliary beam splitter 84 may be provided between the second main beam splitter 26 and the third illumination light source 80. The second auxiliary beam splitter 84 may transmit the third illumination light 16. The second auxiliary beam splitter 84 may reflect fourth illumination light 18 toward the second main beam splitter 26. For example, the second auxiliary beam splitter 84 may include a dichroic mirror.

A second quarter-wave plate 86 may be provided between the second main beam splitter 26 and the second auxiliary beam splitter 84. The second quarter-wave plate 86 may polarize the third illumination light 16 and the fourth illumination light 18. The third illumination light 16 and the fourth illumination light 18 may be circularly polarized.

The third nonlinear crystal plate 46 may be provided between the second auxiliary beam splitter 84 and the third illumination light source 80. The third nonlinear crystal plate 46 may increase a bandwidth of the third illumination light 16. The third nonlinear crystal plate 46 may have a third thickness T3 smaller than a second thickness T2. For example, the third nonlinear crystal plate 46 may have a third thickness T3 of approximately 5 mm to approximately 7 mm. The third nonlinear crystal plate 46 may include BBO (Beta Barium Borate), PPKTP (Periodically Poled Potassium Titanyl Phosphate), PPLN (Periodically Poled Lithium Niobate), silicon (Si), silicon nitride (SiN), aluminum gallium arsenide (AlGaAs), or silicon carbide (SiC).

The fourth illumination light source 90 may be provided adjacent to the third illumination light source 80. The fourth illumination light source 90 may provide the fourth illumination light 18 to the substrate W. The fourth illumination light 18 may have a wavelength that is shorter than that of the third illumination light 16. The fourth illumination light 18 may have a wavelength of approximately 600 nm.

A second mirror 92 may be provided between the fourth illumination light source 90 and the second auxiliary beam splitter 84. The second mirror 92 may reflect the fourth illumination light 18 to the second auxiliary beam splitter 84.

The fourth nonlinear crystal plate 48 may be provided between the second mirror 92 and the fourth illumination light source 90. The fourth nonlinear crystal plate 48 may increase a bandwidth of the fourth illumination light 18. The fourth nonlinear crystal plate 48 may have a fourth thickness T4 smaller than the third thickness T3. The fourth thickness T4 may be approximately 1 mm to approximately 3 mm. The fourth nonlinear crystal plate 48 may include BBO (Beta Barium Borate), PPKTP (Periodically Poled Potassium Titanyl Phosphate), PPLN (Periodically Poled Lithium Niobate), silicon (Si), silicon nitride (SiN), aluminum gallium arsenide (AlGaAs), or silicon carbide (SiC).

A stage 10, an objective lens 20, a holographic phase pattern 22, a first main beam splitter 24, an imaging optical system 30, an image sensor 40, and a controller 50 may be configured the same as in FIG. 1.

The substrate inspection apparatus according to an embodiment of the inventive concept may detect defects at various depths of the substrate using the first and second illumination light having different wavelengths.

The embodiments have been described in the drawings and the specification. While specific terms were used, they were not used to limit the meaning or the scope of the inventive concept described in the claims but merely used to explain an embodiment of the inventive concept. Accordingly, those skilled in the art will understand that various modifications and other equivalent embodiments are also possible. Hence, the real protective scope of the present disclosure shall be determined by the technical scope of the accompanying claims.

What is claimed is:

1. A substrate inspection apparatus comprising:
a stage configured to accommodate a substrate;
an image sensor disposed on the stage;
an objective lens disposed between the image sensor and the stage and configured to project an image of the substrate;
an imaging optical system disposed between the objective lens and the image sensor;
a first main beam splitter disposed between the imaging optical system and the objective lens;
a first illumination light source disposed at one side of the first main beam splitter and configured to provide first illumination light to a first depth of the substrate; and
a second illumination light source disposed adjacent to the first illumination light source and configured to provide second illumination light source, which has a wavelength shorter than that of the first illumination light source, to a second depth, which is shallower than the first depth, through the first main beam splitter.

2. The substrate inspection apparatus of claim 1, wherein the first illumination light has a first wavelength of about 910 nm, and
the second illumination light has a second wavelength of about 800 nm.

3. The substrate inspection apparatus of claim 1, further comprising a holographic phase pattern disposed between the first main beam splitter and the objective lens and configured to increase in focal depth of each of the first and second illumination light.

4. The substrate inspection apparatus of claim 3, wherein the holographic phase pattern has a donut shape.

5. The substrate inspection apparatus of claim 1, further comprising:
a controller configured to acquire first and second images using a detection signal acquired from the image sensor; and
a digital delay pulse generator connected between the first and second illumination light sources and the controller to provide pulses to the first and second illumination light sources.

6. The substrate inspection apparatus of claim 1, further comprising:
a first quarter wave plate disposed between the first illumination light source and the first main beam splitter;
a first auxiliary beam splitter disposed between the first illumination light source and the first quarter wave plate and configured to transmit the first illumination light and reflect the second illumination light to the first quarter wave plate; and
a first nonlinear crystal plate disposed between the first illumination light source and the first auxiliary beam splitter and having a first thickness.

7. The substrate inspection apparatus of claim 6, further comprising:
a first mirror disposed between the second illumination light source and the first auxiliary beam splitter; and
a second nonlinear crystal plate disposed between the first mirror and the second illumination light source and having a second thickness, which is less than the first thickness.

8. The substrate inspection apparatus of claim 7, further comprising:
a second main beam splitter disposed between the objective lens and the imaging optical system and arranged in a direction intersecting the first main beam splitter;
a third illumination light source disposed at one side of the second main beam splitter and configured to provide third illumination light having a third wavelength, which is shorter than the second wavelength of the second illumination light;
a second auxiliary beam splitter disposed between the third illumination light source and the second main beam splitter; and
a third nonlinear crystal plate disposed between the third illumination light source and the second auxiliary beam splitter and having a third thickness, which Is less than the second thickness.

9. The substrate inspection apparatus of claim 8, further comprising a fourth illumination light source disposed adjacent to the third illumination light source and configured to provide fourth illumination light having a fourth wavelength, which is shorter than the third wavelength, to the second auxiliary beam splitter.

10. The substrate inspection apparatus of claim 9, further comprising:
a second mirror disposed between the fourth illumination light source and the second auxiliary beam splitter; and
a fourth nonlinear crystal plate having a fourth thickness, which is less than the third thickness.

11. A substrate inspection apparatus comprising:
a stage configured to accommodate a substrate;
an image stage disposed on the stage;
an objective lens disposed on the image sensor and the stage;
an imaging optical system disposed between the objective lens and the image sensor;
first and second main beam splitters disposed between the imaging optical system and the objective lens;
first and second illumination light sources disposed at one side of the first and second main beam splitters to provide first and second illumination light to the substrate, respectively; and
third and fourth illumination light sources disposed at the other side of the first and second main beam splitters to provide third and fourth illumination light to the substrate, respectively.

12. The substrate inspection apparatus of claim 11, further comprising:
a first nonlinear crystal plate disposed between the first and second main beam splitters and the first illumination light source and having a first thickness; and
a second nonlinear crystal plate disposed between the first and second main beam splitters and the second illumination light source and having a second thickness, which is less than the first thickness.

13. The substrate inspection apparatus of claim 12, wherein the first thickness ranges from about 13 mm to about 15 mm, and
the second thickness ranges from about 9 mm to 11 about mm.

14. The substrate inspection apparatus of claim 11, further comprising:
a third nonlinear crystal plate disposed between the first and second main beam splitters and the third illumination light source and having a third thickness; and
a fourth nonlinear crystal plate disposed between the first and second main beam splitters and the fourth illumination light source and having a fourth thickness, which is less than the third thickness.

15. The substrate inspection apparatus of claim 14, wherein the third thickness ranges from about 5 mm to about 7 mm, and
the fourth thickness ranges from about 1 mm to about 3 mm.
